(19) United States
(12) Patent Application Publication
(10) Pub. No.: US 2011/0273298 A1
(43) Pub. Date: Nov. 10, 2011

(54) Apparatus and Method for Monitoring Hygiene

(76) Inventors: David L. Snodgrass, Stuart, FL (US); Joel S. Douglas, Groton, CT (US)

(21) Appl. No.: 12/684,034

(22) Filed: Jan. 7, 2010

Related U.S. Application Data
(60) Provisional application No. 61/204,621, filed on Jan. 8, 2009.

(51) Int. Cl. G08B 23/00

(52) U.S. Cl. 340/573.1

(57) ABSTRACT

Method and apparatus for monitoring and reporting hand washing at a sanitizing station employs a sensor for signaling the dispensation of a sanitizing agent from a dispenser and setting a clear signal to permit passage through a portal, such as an entrance to a room. The module in turn includes an input element, an output element, a processor, and memory. The module operates in person and administrator modes. In the person mode, the module responds to an input signaling that a person has dispensed sufficient sanitizer to mitigate the spread of germs from care giver/health care worker to patient. The person activates the sanitizer to dispense the sanitizer liquid or foam and that action signals that the cleaning agent has been dispensed and turns on the entrance permitted light. If the dispenser is not activated or the amount of sanitizer dispensed is not adequate to sanitize the person's hands, a sensor positioned at the entrance of the door alarms. The apparatus may be installed quickly and easily, at lower cost, in a wide variety of sanitization stations, and can be used with existing, preinstalled sanitization dispensers or with a new dispenser. When in administrator mode, the module allows for passage of beds, equipment and supplies to the room.

### CROSS-REFERENCE TO RELATED APPLICATIONS

This application claims the benefit of U.S. Provisional Patent Application No. 61/204,621 filed Jan. 8, 2009, which is incorporated herein by reference in its entirety.

### FIELD OF THE INVENTION

This invention relates to methods and apparatus for promoting hygiene, and more particularly, for promoting frequent sanitization and hand washing by personnel in facilities such as hospitals, healthcare facilities, foodservice facilities, and restaurants, and by other personnel in frequent contact with the public.

### BACKGROUND OF THE INVENTION

Discovery of penicillin during the middle of the twentieth century, and the development and widespread use of other antibiotics in the decades hence, has been of tremendous benefit in curtailing the spread of infectious disease. Doubtless, antibiotics save lives and help avoid innumerable debilitating incidents of infection. However, as with many scientific advances, there are also limits. Reliance on antibiotics corresponds to an unfortunate de-emphasis of other simple and highly effective means of controlling bacteria, such as frequent washing. Furthermore, the prevalent use, and perhaps over prescription, of antibiotics has lead to a natural selection process that favors those bacteria least affected by the antibiotics. Strains of bacteria are appearing that are highly resistant to many common antibiotics.

Concern with avoiding the spread of infectious disease is particularly high in those industries that deal with the public, such as the healthcare and food service industries. A single person, as a result of one incident of carelessness, such as not washing after using the bathroom, can transmit infectious bacteria to any number of patrons. The results can be disastrous, not only to those infected, but also to the employer's business and reputation. Because the public interest is clearly at issue, the Food and Drug Administration has promulgated regulations that address washing by hospital, foodservice and other personnel. FDA regulations identify hand washing as a “critical item”, such that violations of the rules governing hand washing “are more likely than other violations to lead to food contamination, illness, or environmental degradation”. The FDA regulations further specify that personnel must wash twice after using the bathroom, using a specified wash procedure. The regulations also require that “a person in charge routinely monitor person hand washing to ensure that persons are effectively washing their hands”.

Of course, compliance with hygiene standards must be complete to minimize the chance of the transmission of infection. The failure of one worker to properly sanitize his or her hands can negate the efforts of all other workers who have been careful to properly sanitize their hands before touching patients or handling food. Ensuring complete compliance requires constant diligence on the part of supervisors, who typically have other pressing duties that can distract them from always effectively monitoring the hygiene of persons. Accordingly, there are known in the art systems for automating oversight and record keeping of person hand washing.

For example, U.S. Pat. No. 5,202,666 is directed to ensuring proper person hand washing. Persons are monitored, and carry a receiver and transmitter, preferably in the form of a badge. A multitude of transmitters, receivers and transducers, as well as proximity detectors, switches, valves and a computer, ensure that various activities relating to hand washing, such as dispensing water or soap or activating a blower, do actually occur. An alert signal is generated if the apparatus determines that an individual fails to properly wash, activating a light on the person's badge, reporting to a central computer or otherwise providing a warning.

U.S. Pat. No. 4,986,144 relates to a warning system using a door-activated switch. The switch detects entry to a wash facility, and an alarm warns the person entering to wash their hands prior to leaving or entering. When used in a bathroom, the warning system can be activated by the flushing of toilet, and can lock the door to ensure that the person properly washes their hands before leaving.

As another example, the system described in U.S. Pat. No. 5,670,945 uses two moisture-proof switches for sensing the immersion of both hands of the person in an antiseptic solution. Proximity detectors are installed to sense when a person approaches and moves away from a special wash station adjacent a food handling area. The system activates an alarm if a logic unit determines that a person has approached the washbasin and entered the food handling area without immersing both hands in the antiseptic solution.

U.S. Pat. Nos. 5,683,012, and 5,927,548, describe a novel, body-worn dispenser for alcohol-glycerin disinfectant gel that doctors and nurses can use to disinfect their hands before and after patient contacts. These patents do not disclose any means to monitor, track or record the usage dose applications of the disinfecting gel dispenser nor do they disclose any means for its piston pump which can be variably actuated depending on the amount of pressure applied by the user's hand, to dispense exact dose applications of the disinfecting gel.

U.S. Pat. No. 5,476,194 and U.S. Pat. No. 5,819,986, both describe personal, portable, and refillable fluid dispensers. U.S. Pat. No. 5,476,194 describes an attachment means for a dispenser device to be worn on the body of the user. U.S. Pat. No. 5,819,986 describes a piston action pump to deliver an amount of fluid. Neither of these patents discloses any method or apparatus to provide uniform unit dose applications of the fluid dispensed or methods to monitor, track, record and report usage information of a fluid dispenser.

U.S. Pat. No. 5,945,910 describes a method and apparatus for monitoring and reporting hand washing, and U.S. Pat. No. 5,670,945 describes a self-monitoring, hand-sanitizing station. U.S. Pat. No. 5,202,666 describes a method and apparatus for enhancing hygiene. The preceding three (3) patents refer in general to a non-portable wash station that many people access to wash their hands. Each patent describes separate novel methods and apparatus to monitor, record and report various hand washing activity that occurs at a given wash station.

U.S. Pat. No. 5,492,247 describes a fluid reservoir that is replaceable from a rigidly mounted dispenser utilized by many users. U.S. Pat. No. 4,722,372 further describes a dispenser for multiple user access with a disposable fluid reservoir.

U.S. Pat. No. 5,226,462 discloses a unique method and apparatus to accurately introduce measured amounts of liquid into receptacles. Additionally, U.S. Pat. No. 4,135,561 describes a similar method and apparatus for filling vials in an automated system.

Although there are a considerable number of patents issued for automatically refilling apparatus and methods, there does not appear to be any prior art which directly relates to refilling a hand-held, hand-operated, personal, and portable fluid dispenser, that upon its refilling process, the amount of fluid used to refill said dispenser is recorded as to determine how much fluid was used over a certain time frame by a specific dispenser and by a specific user.

### SUMMARY OF THE INVENTION

Unfortunately, known systems can be relatively complex, and there is a need for a system which provides feed back for a person to remind them that they need to sanitize their hands prior to passing through a portal, such as a door entering a patient's room or area that requires hand-sanitizing, such as food prep areas. Accordingly, it is an object of the present invention to provide a method and apparatus for promoting hand hygiene.

A second aspect of the hospital environment is issue associated with cost control. The invention addresses this major concern by providing an easy-to-implement retrofit for existing hand-sanitizing systems. The stand-alone nature of the invention makes it easy to implement.

Another object of the present invention is to provide a method and apparatus for monitoring and reporting hand-washing by selected personnel.

Yet another object of the invention is to provide an economical apparatus for monitoring that hand-washing has been done, that is simple to use, and more readily-installed or retrofitted in existing facilities, thereby promoting compliance with hygiene requirements.

Yet another object of the invention, is to provide a means to assure that a sufficient amount of cleaner is dispensed to ensure thorough hand-cleaning

The present invention provides a simple and economical apparatus for hand-washing by persons. The apparatus is activated by a person when they dispense a sufficient amount of sanitizer to thoroughly sanitize their hands. This is significant because many times a person does not dispense a sufficient amount of sanitizer and does not adequately sanitize their hands. This is accomplished by locating a switch inside of the hand sanitizer that requires the complete depression of the sanitizer dispenser. The activated switch then changes the indicator lights that signify that the person has sanitized their hands and may pass through a portal to enter a room. If the person does not activate the dispenser and enters the room, a door way sensor will detect the person entering the room and an alarm will sound. The switch is set to assure that the dispenser is fully-depressed to ensure that the correct amount of sanitizer is dispensed, or it will not allow access to the room and keep the do-no-enter-light illuminated. By doing this, the user is prevented from inadequate dispensing and incomplete cleaning practices. The sensor can be optical, magnetic, mechanical, electronic, or any means that allows for the sensing of an adequate amount of cleaner to sanitize a person's hands. The sanitizer dispenser can be either manually-activated or auto-device, which dispenses the sanitizer when a hand is presented to the dispenser.

The proposed device can be used either with the alarm or without it, and it can also be configured with or without, a visual display, such as a video display, LCD display, lights or LED lights.

The control unit, sensors, or indicator device, can be either connected to the sanitizer dispenser by discrete wiring, conductive tape, or through a wireless communication system, such as WIFI or a proprietary wireless network.

The control unit will allow the device to be set into a mode to indicate additional hand-washing requirements to the user if an administrator determines that hand-sanitization through the connected dispenser is not sufficient, as would be the case when sport-forming pathogens, such as Clostridium difficile, are present or suspected. In this mode of operation, the control unit may be connected to an automatic-sink and soap-based hand-washing system, and indicate compliance only following the proper use of the soap and water-based hand-washing procedure.

The invention provides an apparatus for enhancing hygiene, comprising: a first monitor in communication with a dispensing device for a sanitizing agent, said monitor being activated when a certain amount of sanitizing agent has been dispensed; a second monitor for automatically detecting when an individual has passed through a portal; a first alert indicator operatively connected to said first monitor and said second monitor, and for generating an alert signal upon detecting that an individual has passed through said portal and has not executed activation of said first monitor during a certain time interval.

The invention provides an apparatus for enhancing hygiene, comprising: a first monitor with a dispensing device for a sanitizing agent, said first monitor being activated when a certain amount of sanitizing agent has been dispensed; a second monitor for automatically detecting when an individual has passed through a portal; a first alert indicator operatively connected to said first monitor and said second monitor for automatically generating an alert signal upon detecting that an individual has passed through said portal and has not executed activation of said first monitor during a certain time interval; and a second alert indicator operatively connected to said first monitor for generating a second alert signal upon detecting that the first monitor has been activated.

The invention provides a method for monitoring and enhancing hygiene, comprising: providing a first monitor in communication with a dispensing device for a sanitizing agent; activating said monitor when a certain amount of sanitizing agent has been dispensed; providing a second monitor to detect when an individual has passed through a portal; providing a first alert indicator operatively connected to said first monitor and said second monitor; and generating an alert signal upon detecting that an individual has passed through said portal and has not executed activation of said first monitor during a certain time interval.

The invention provides a method for enhancing hygiene, comprising: providing a first monitor with a dispensing device for a sanitizing agent; activating said first monitor being activated when a certain amount of sanitizing agent has been dispensed; providing a second monitor for automatically detecting when an individual has passed through a portal; providing a first alert indicator operatively connected to said first monitor and said second monitor; generating an alert signal upon detecting that an individual has passed through said portal and has not executed activation of said first monitor during a certain time interval; providing a second alert indicator operatively connected to said first monitor; and generating a second alert signal upon detecting that the first monitor has been activated.

### BRIEF DESCRIPTION OF THE DRAWINGS

FIG. 1 is a block diagram of the sanitizer monitoring system;

FIG. 2 is a flow-chart of the control algorithm of the invention; and

FIG. 3 is a diagram of the conductive tape used to provide connections for the sanitizer monitoring system

### DETAILED DESCRIPTION OF THE PREFERRED EMBODIMENT

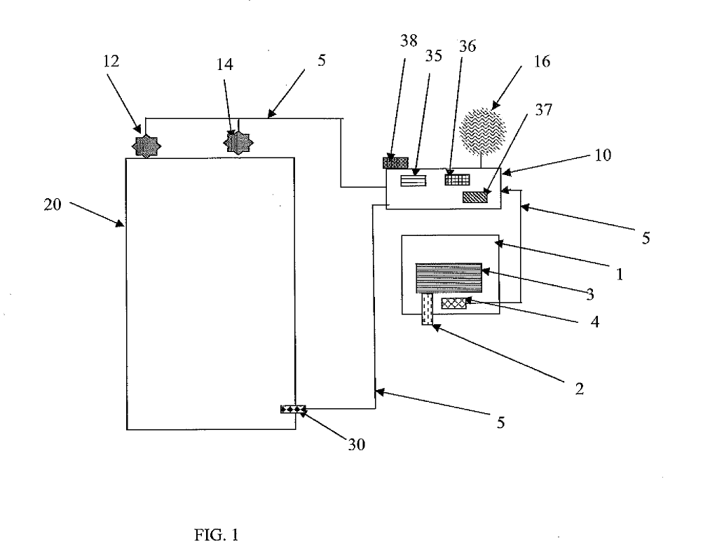

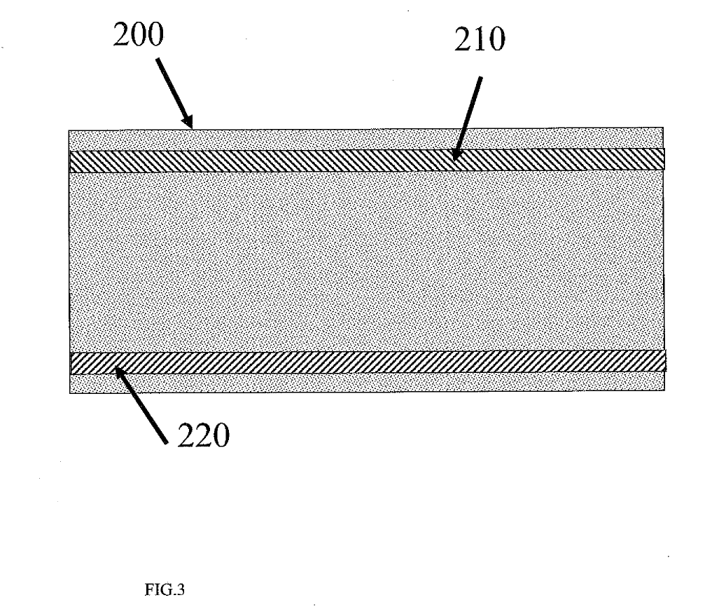

Referring to FIG. 1, the fluid dispenser 1 is either a hand-operated or auto-dispense type dispenser. It comprises a fluid-ejection nozzle 2, sanitizer reservoir 3, dispensing sensor 4, and signal device 5. Signal device 5 can be wired connector, WIFI signal, or proprietary wireless signal. The preferred wired conductor is a conductive tape (FIG. 3) that allows the electrical signal to pass through the signal device. Dispensing sensor 4 can be selected from switches that are mechanical, magnetic, passive-infrared, optical, infrared, conductive, or pressure activated.

The fluid-ejection nozzle 2 is positioned to dispense fluid from the sanitizer reservoir 3 when the dispenser is activated. The activation can be either manually or automatic.

A controller 10 receives the signal from dispensing sensor 4 via the signal device 5. If the dispensing sensor 4 is activated the controller 10 illuminates the “able-to-pass” signal 14 for a specific amount of time which indicates that the person can pass through the portal 20. After the specific amount of time has expired the controller 10 illuminates the “do-not-pass” signal 12.

If a person enters the portal 20 without activating the dispensing sensor 4, the portal sensor 30 will provide a signal via the signal device 5 to the controller 10, the “do-not-pass” signal 12 is illuminated, and alarm 16 is activated. This reminds the person entering the room or area that they need to sanitize their hands. Alarm 16 can be any audible indicator that meets the requirements of the installation such as ring-tone, buzzer, beep, or voice. The portal sensor 30 can be selected from switches that are mechanical, ultra-sonic, magnetic, optical, infrared, passive-infrared, conductive, pressure-activated, or mechanical electronic.

The system can also be configured so that it has a bypass mode that is activated by bypass switch 35. This allows equipment and beds to be moved in and out of the area without the alarm 16 being activated.

The counter switch 36 allows access to the counters so that statistical information can be collected from the controller. The access is by a direct communication to a computer by way of a USB, serial or parallel communication port 37.

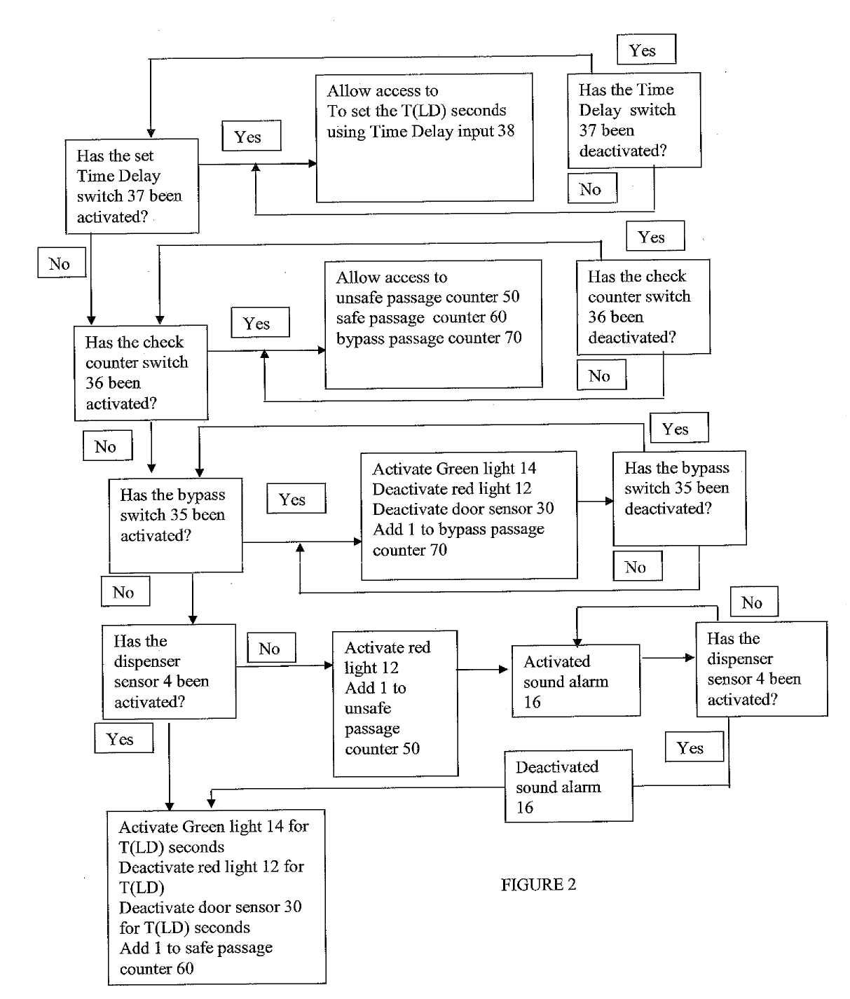

Referring to FIG. 2, a flow chart of the control algorithm according to one aspect of the invention is shown. If the counter switch 36 has been activated, the controller allows access to the unsafe passage counter 50, safe passage counter 60, bypass passage counter 70, until the counter switch 36 is deactivated. During that time the counters can be down-loaded and/or zeroed by the authorized staff. The counter switch 36 can be electronic entry, key switch, or recessed button switch, which minimizes or eliminates unauthorized activation. If the Time Delay switch 37 has been activated, then the authorized staff can reset the time delay for the portal entrance time. This can be accomplished by direct communication with the controller, or by adjusting the Time Delay input 38 which can be a potentiometer, push button switches, rotary switches, or any other means of communicating with the controller the amount of time for the delay.

If the bypass switch 35 has been activated, then the controller will Activate Green light 14, Deactivate Red light 12, Deactivate door sensor 30, and Add 1 to bypass passage counter 70 until the bypass switch 35 been deactivated.

If the dispenser sensor 4 has been activated, the controller will then set the Activate Green light 14 on for T(LD) seconds, Deactivate red light 12 for T(LD), Deactivate door sensor 30 for T(LD) seconds, and Add 1 to safe passage counter 60.

If the dispenser sensor 4 is not activated, and the door sensor is activated, the controller will Activate red light 12, Add 1 to unsafe passage counter 50, and Activate sound alarm 16 until the dispenser sensor 4 been activated.

The apparatus is activated by an employee when they dispense sufficient sanitizer to thoroughly sanitize their hands. This is significant, because many times the employee does not dispense a sufficient amount of sanitizer, and thus does not adequately sanitize their hands. This is accomplished by locating a switch inside the hand sanitizer that requires the complete depression of the sanitizer dispenser. This switch then changes the indicator lights that indicate that the employee can enter the room. If the employee does not activate the dispenser and enters the room, a doorway sensor will detect the employee entering the room, and an alarm will be triggered. The switch is set to ensure that the dispenser is fully-depressed to ensure that the correct amount of cleaner is dispensed, or it will not allow access to the room. By doing this, the user is stopped from inadequate dispensing and clean practices. The sensor can be mechanical, ultra-sonic, magnetic, optical, infrared, passive-infrared, conductive pressure activated, mechanical, electronic, or any means that allows for the sensing of an adequate amount cleaner to sanitize a person's hands.

The proposed device can be used either with the alarm, or without. The alarm can be audio and/or a visual display, such as a light or LED display.

Referring to FIG. 3, a conductive tape is used to provide connections for the sanitizer monitoring system. This eliminates the need to run costly wires or conduit to form the signal device to connect the sensor to the stand-alone hand sanitizer dispenser. The conductive tape 200 has two conductive tracks 210 and 220 printed or laminated to the tape. The conductive tracks 210 and 220 are used to transport the signal device. First, the tape is attached to the wall of the hospital, and the conductive tracks 210 and 220, are attached so they are in communication with the controller 10, dispensing sensor 4 and the portal sensor 30. The communication can be either through soldering or ultrasonic bonding.

Additionally, the control unit can be configured to allow the device to be set into a mode to indicate additional hand-washing requirements to the user, if an administrator determines that hand-sanitization through the connected dispenser is not sufficient, as would be the case when sport-forming pathogens, such as Clostridium difficile, are present or suspected. In this mode of operation, the control unit 10, may be connected by communication device 5 to an automatic sink with faucet that uses a soap-based hand-washing system and indicates compliance only following the proper use of the soap-and-water-based hand-washing procedure. In this case, the controller 10 transfers control to sink and faucet controller which is connected to Sink and faucet and does not allow access through the portal until a hand-washing-complete is indicated by the communication device 5 to the controller 10.

It should also be understood, that an aspect of the present invention can employ a control station with agent dispensers that are pre-filled with cleaning agent, and are to be properly discarded after use. The controller can be either a separate module or integrated into the sanitizer dispenser.

Therefore, while the invention has been illustrated and described in detail in the drawings and foregoing description, the same is to be considered as illustrative and not restrictive in character, it being understood that only the preferred embodiments have been shown and described and that all changes and modifications that come within the spirit and scope of the following claims and equivalents are desired to be protected.

What is claimed is:

1. An apparatus for enhancing hygiene, comprising:
a first monitor in communication with a dispensing device for a sanitizing agent, said monitor being activated when a certain amount of sanitizing agent has been dispensed;
a second monitor for automatically detecting when an individual has passed through a portal;
a first alert indicator operatively connected to said first monitor and said second monitor, and for generating an alert signal upon detecting that an individual has passed through said portal and has not executed activation of said first monitor during a certain time interval.

2. The apparatus of claim 1, comprising a second alert indicator operatively connected to the first monitor for automatically generating a signal upon detection of a certain amount of fluid being dispensed.

3. The apparatus recited in claim 1, wherein said first monitor is selected from the group consisting of a mechanical switch, an ultrasonic detector, an optical switch, an infrared detector, a magnetic switch, a pressure-activated switch, and a conductive switch.

4. The apparatus recited in claim 1, wherein said second monitor is selected from the group consisting or a mechanical switch, an ultrasonic switch, an optical switch, an infrared detector, a magnetic switch, a pressure-activated switch, and a conductive switch.

5. The apparatus recited in claim 1, wherein the first monitor is in wireless communication with the first alert indicator with a wireless communication link.

6. The apparatus recited in claim 1, wherein the second monitor is in wireless communication with the first alert indicator with a wireless communication link.

7. The apparatus recited in claim 1, wherein the first monitor is in communication with the first alert indicator with a wired conductive element.

8. The apparatus recited in claim 7, wherein the conductive element is in the form of a tape.

9. The apparatus recited in claim 1, wherein the second monitor is in communication with the first alert indicator with a wired conductive element.

10. The apparatus recited in claim 9, wherein the conductive element is in the form of a tape.

11. The apparatus recited in claim 1, comprising a user-settable switch for selecting one of a plurality of sanitizing procedures depending on the pathogen for which hygiene is being enhanced.

12. The apparatus recited in claim 1, further comprising a sink for performing handwashing.

13. The apparatus recited in claim 1, wherein the sanitizing agent is in the form of a foam.

14. The apparatus recited in claim 1, wherein the second monitor comprises an infrared detector.

15. The apparatus recited in claim 14, wherein the detector is located above the portal.

16. An apparatus for enhancing hygiene, comprising:
a first monitor with a dispensing device for a sanitizing agent, said first monitor being activated when a certain amount of sanitizing agent has been dispensed;
a second monitor for automatically detecting when an individual has passed through a portal;
a first alert indicator operatively connected to said first monitor and said second monitor for automatically generating an alert signal upon detecting that an individual has passed through said portal and has not executed activation of said first monitor during a certain time interval; and
a second alert indicator operatively connected to said first monitor for generating a second alert signal upon detecting that the first monitor has been activated.

17. The apparatus of claim 16 comprising a switch to activate a bypass mode to deactivate the first alert indicator.

18. The apparatus of claim 16 comprising a switch and input device to adjust the time interval.

19. The apparatus of claim 16 comprising a storage device for recording the number of safe passages of an individual passing through the portal without an alert signal, and unsafe passages of an alert signal being generated.

20. The apparatus recited in claim 16, wherein said first monitor is selected from the group consisting of a mechanical switch, an ultrasonic detector, an optical switch, an infrared detector, a magnetic switch, a pressure-activated switch, and a conductive switch.

21. The apparatus recited in claim 16, wherein said second monitor is selected from the group consisting or a mechanical switch, an ultrasonic switch, an optical switch, an infrared detector, a magnetic switch, a pressure-activated switch, and a conductive switch.

22. The apparatus recited in claim 16, wherein the first monitor is in wireless communication with the first alert indicator with a wireless communication link.

23. The apparatus recited in claim 16, wherein the second monitor is in wireless communication with the first alert indicator with a wireless communication link.

24. The apparatus recited in claim 16, wherein the first monitor is in communication with the first alert indicator with a wired conductive element.

25. The apparatus recited in claim 24, wherein the conductive element is in the form of a tape.

26. The apparatus recited in claim 16, wherein the second monitor is in communication with the first alert indicator with a wired conductive element.

27. The apparatus recited in claim 26, wherein the conductive element is in the form of a tape.

28. The apparatus recited in claim 16, comprising a user-settable switch for selecting one of a plurality of sanitizing procedures depending on the pathogen for which hygiene is being enhanced.

29. The apparatus recited in claim 16, further comprising a sink for performing handwashing.

30. The apparatus recited in claim 16, wherein the sanitizing agent is in the form of a foam.

31. A method for monitoring and enhancing hygiene, comprising:
providing a first monitor in communication with a dispensing device for a sanitizing agent;
activating said monitor when a certain amount of sanitizing agent has been dispensed;
providing a second monitor to detect when an individual has passed through a portal;
providing a first alert indicator operatively connected to said first monitor and said second monitor; and
generating an alert signal upon detecting that an individual has passed through said portal and has not executed activation of said first monitor during a certain time interval.

32. The method of claim 31, comprising using a second alert indicator operatively connected to the first monitor for automatically generating a signal upon detection of a certain amount of fluid being dispensed.

33. The method recited in claim 31, wherein said first monitor is selected from the group consisting of a mechanical switch, an ultrasonic detector, an optical switch, an infrared detector, a magnetic switch, a pressure-activated switch, and a conductive switch.

34. The method recited in claim 31, wherein said second monitor is selected from the group consisting or a mechanical switch, an ultrasonic switch, an optical switch, an infrared detector, a magnetic switch, a pressure-activated switch, and a conductive switch.

35. The method recited in claim 31, wherein the first monitor is in wireless communication with the first alert indicator with a wireless communication link.

36. The method recited in claim 31, wherein the second monitor is in wireless communication with the first alert indicator with a wireless communication link.

37. The method recited in claim 31, wherein the first monitor is in communication with the first alert indicator with a wired conductive element.

38. The method recited in claim 37, wherein the conductive element is in the form of a tape.

39. The method recited in claim 31, wherein the second monitor is in communication with the first alert indicator with a wired conductive element.

40. The method recited in claim 39, wherein the conductive element is in the form of a tape.

41. The method recited in claim 31, comprising using a user-settable switch for selecting one of a plurality of sanitizing procedures depending on the pathogen for which hygiene is being enhanced.

42. The method recited in claim 31, further comprising providing a sink for performing handwashing.

43. The method recited in claim 31, wherein the sanitizing agent is in the form of a foam.

44. The method recited in claim 31, wherein the second monitor comprises an infrared detector.

45. The method recited in claim 44, comprising locating the detector above the portal.

46. A method for enhancing hygiene, comprising:
providing a first monitor with a dispensing device for a sanitizing agent;
activating said first monitor being activated when a certain amount of sanitizing agent has been dispensed;
providing a second monitor for automatically detecting when an individual has passed through a portal;
providing a first alert indicator operatively connected to said first monitor and said second monitor;
generating an alert signal upon detecting that an individual has passed through said portal and has not executed activation of said first monitor during a certain time interval;
providing a second alert indicator operatively connected to said first monitor; and
generating a second alert signal upon detecting that the first monitor has been activated.

47. The method recited in claim 46 comprising using a switch to activate a bypass mode to deactivate the first alert indicator.

48. The method recited in claim 46 comprising using a switch and input device to adjust the time interval.

49. The method recited in claim 46 comprising using a storage device for recording the number of safe passages of an individual passing through the portal without an alert signal, and unsafe passages of an alert signal being generated.

50. The method recited in claim 46, wherein said first monitor is selected from the group consisting of a mechanical switch, an ultrasonic detector, an optical switch, an infrared detector, a magnetic switch, a pressure-activated switch, and a conductive switch.

51. The method recited in claim 46, wherein said second monitor is selected from the group consisting or a mechanical switch, an ultrasonic switch, an optical switch, an infrared detector, a magnetic switch, a pressure-activated switch, and a conductive switch.

52. The method recited in claim 46, wherein the first monitor is in wireless communication with the first alert indicator with a wireless communication link.

53. The method recited in claim 46, wherein the second monitor is in wireless communication with the first alert indicator with a wireless communication link.

54. The method recited in claim 46, wherein the first monitor is in communication with the first alert indicator with a wired conductive element.

55. The method recited in claim 54, wherein the conductive element is in the form of a tape.

56. The method recited in claim 46, wherein the second monitor is in communication with the first alert indicator with a wired conductive element.

57. The method recited in claim 56, wherein the conductive element is in the form of a tape.

58. The method recited in claim 46, comprising using a user-settable switch for selecting one of a plurality of sanitizing procedures depending on the pathogen for which hygiene is being enhanced.

59. The method recited in claim 46, further comprising providing a sink for performing handwashing.

60. The method recited in claim 46, wherein the sanitizing agent is in the form of a foam.
